(19) United States
(12) Patent Application Publication
(10) Pub. No.: US 2020/0188202 A1
(43) Pub. Date: Jun. 18, 2020

(54) Stand Assist Device

(71) Applicant: Ko-Po Chen, Taichung (TW)

(72) Inventors: Ko-Po Chen, Taichung (TW); Meng-Lung Fang, Taichung (TW)

(21) Appl. No.: 16/217,183

(22) Filed: Dec. 12, 2018

(51) Int. Cl. A61G 5/14; A61G 5/10

(52) U.S. Cl. CPC A61G 5/14; A61G 5/1059

(57) ABSTRACT

The present invention provides a stand assist device, which comprises a first frame body, a second frame body, a first supporting member, a second supporting member, a power unit; the first frame body is having a first pivoting part and a first guiding portion; the second frame body is having a second pivoting part and a second guiding portion; the front side of the first supporting member is pivotally connected to the first pivoting part and the rear side of the first supporting member is movably disposed on the second guiding portion; the front side of the second supporting member is pivotally connected to the second pivoting part and the rear side of the second supporting member is movably disposed on the first guiding portion; the power unit provides a power to relatively move or swing the first frame body, the second frame body, wherein two of them swing relatively, thereby providing a vertical upward supporting force, which makes the user more stable and comfortable in the process of changing from a sitting posture to a standing posture, and then giving a tilting upward force to assist the user to stand.

### FIELD OF THE INVENTION

The present invention relates to a device having a stand assisting function, which is provided for the user to sit and assist the user to stand up from the sitting posture.

### BACKGROUND OF THE INVENTION

With the economic progress nowadays, purchasing power has gradually increased, more and more people have ability to pursue a better life quality. In addition, the aging population comes with the improved medical quality, the elderly people with slow or inconvenient actions has increased. People care about living quality and the safety of elderly, the seats tend to equipped with a variety of convenient additional functions in these days. One of the important functions is stand assisting function, which can assist the users to stand from sitting posture.

Most of the marketed stand assist devices lift the users from the horizontal state to the front side. Such as the lifting seat invented by the TWI583333 patent, wherein the lift mechanism of the lifting seat invented by TWI583333 includes a lift motor and a drive assembly having a slider coupled to the lift motor, and the lifting tube will connect the slider to the seat. When the lifting motor is actuated, the lifting tube can be displaced in the sliding up direction by the movement of the sliding member, so that the seat part is inclined upwards to achieve the effect of assisting the user to get up. However, since the seat is used to tilted forward the user directly from sitting posture, and the user is less comfortable in the process of getting up. For those who moves slowly or those who are inconvenient, they are more likely to have concerns about falling.

The previous Taiwan patent application, TWM543067, provides another kind of stant assist device, which provides a first rotating part, a second rotating part, a first adjusting part and a second adjusting part to rotate the seat to lift the seat. When the seat level rises to a certain height, the seat is tilted forward by the action of the second power component, thereby assisting the user to stand up. However, the stand assist device needs to lift the entire seat for lifting and lowering. The action requires a large amount of power, and the coordinated action of the two sets of adjustment members and the power components inevitably complicates the overall structure.

### SUMMARY OF THE INVENTION

One purpose of the present invention is to provide a stand assist device, which can be used to seat and assist the user to stand up from the seated state, and provide a labor-saving and comfortable experience during the getting up process. For the elderly or the disabled who move slowly, the present invention provides a safer way for users to get up.

Secondly, the stand assist device of the present invention can be used as a seat cushion alone or in the form of a seat on a seat frame, which provides a convenient use manner. Besides, the stand assist device of the present invention mainly loads only the weight of the user, it can save electricity and increase the life of parts to achieve the goal of environmental protection.

For the above purposes, this present invention provides stand assist device, comprises a first frame body, a second frame body, a first supporting member, a second supporting member, and a power part. The first frame body defines a first reference surface. The first frame body is having a first pivoting part and a first guiding portion. The second frame body defines a second reference surface. The second frame body is having a second pivoting part and a second guiding portion. A front side of the first supporting member is pivotally connected to the first pivoting part, and a rear side of the first supporting member is movably disposed on the second guiding portion to make the rear of the first supporting member can move relatively to the second frame along a first path. A front side of the second supporting member is pivotally connected to the second pivoting part, and a rear side of the second supporting member is movably disposed on the first guiding portion to make the rear of the second supporting member can move relatively to the second frame along a second path, and the second supporting member is pivotally connected to the first supporting member. The power unit provides a power to relatively move or swing the first frame body, the second frame body, the first supporting member and the second supporting member to cause the first reference surface and the second reference surface relatively moving closer to or away from each other. The first path and the second path are partially non-parallel, so that the first reference surface and the second reference surface are relatively swing when moving relative to each other.

In some embodiments of the present invention, the first guiding portion is having a first horizontal groove and a first inclined groove. The first horizontal groove is parallel to the first reference surface. The first inclined groove is not parallel to the first reference surface. The first horizontal groove extends away from the first pivoting part from one end of the first inclined groove. The second path extends along the first horizontal groove and the first inclined groove.

In some embodiments of the present invention, the angle between the first horizontal groove and the first inclined groove is greater than 90 degrees.

In some embodiments of the present invention, the second guiding portion is having a second horizontal groove and a second inclined groove. The second horizontal groove is parallel to the second reference surface. The second inclined groove is not parallel to the second reference surface. The second horizontal groove extends away from the second pivoting part from one end of the second inclined groove. The first path extends along the second horizontal groove and the second inclined groove.

In some embodiments of the present invention, the angle between the second horizontal groove and the second inclined groove is greater than 90 degrees.

In some embodiments of the present invention, when the first reference surface and the second reference are moved closer to each other, the first inclined groove and the second inclined groove are at least partially located at a same level.

In some embodiments of the present invention, the first guiding portion is having an arcuate groove. A rear side of the second supporting member is disposed on the arcuate groove and can move along the arcuate groove.

In some embodiments of the present invention, the first guiding portion is having a connecting rod. The connecting rod is pivotable relative to the first reference surface. The connecting rod is having a first horizontal groove. The rear side of the second supporting members is disposed on the first horizontal groove and can move along the first horizontal groove.

Further, the present invention provides a seat, comprising a back frame and a seat frame. The back frame is connected to the seat frame. The second frame body is disposed on the seat frame.

Thereby, the rear side of the second supporting member moves along the second path relative to the first reference surface during the pushing of the power part, and the rear side of the first supporting member moves relative to the second reference surface along the first path. Wherein the first path and the second path are partially non-parallel, the first reference surface and the second reference surface are relatively yawed when moving relative to each other, so that the first frame can be vertically raised for a certain distance first and then tilted up to the front side.

When the user gets up from the seated state, the user's feet are gradually extended from the hips to the feet during the process of gradually stretching the knees. The stand assist device of the present invention provides vertical upward supporting force for the user. It provides more stable and comfortable during the process of posture change, and then gives a tilting upward force to help the user to stand, which can better meet the supporting force required by the human body to sit and stand. Secondly, the stand assist device of the present invention is provided for the user to seat in the first frame body, and the first frame body is lifted and tilted by the linkage mechanism, and only one set of power unit is needed to complete the stand assisting function. Thus, the stand assist device can be simplified. Furthermore, the power required for overall action of the stand assist device is reduced.

### BRIEF DESCRIPTION OF THE DRAWINGS

FIG. 1 is a perspective view showing a first embodiment of the stand assist device of the present invention.

FIG. 2 is an exploded perspective view showing the first embodiment of the stand assist device of the present invention.

FIG. 3 is a lateral view of the first embodiment of the stand assist device of the present invention.

FIG. 4 and FIG. 5 are schematic views showing the lifting state of the first embodiment of the stand assist device of the present invention.

FIG. 6 is a side elevational view of another embodiment of the stand assist device of the present invention.

FIG. 7 is a perspective view showing a second embodiment of the stand assist device of the present invention.

FIG. 8 is a lateral view of the second embodiment of the stand assist device of the present invention.

FIG. 9 and FIG. 10 are schematic views showing the lifting state of the second embodiment of the stand assist device of the present invention.

FIG. 11 and FIG. 12 are schematic views showing the operational conditions of the stand assist device which is installed in a seat.

### DETAILED DESCRIPTION OF THE INVENTION

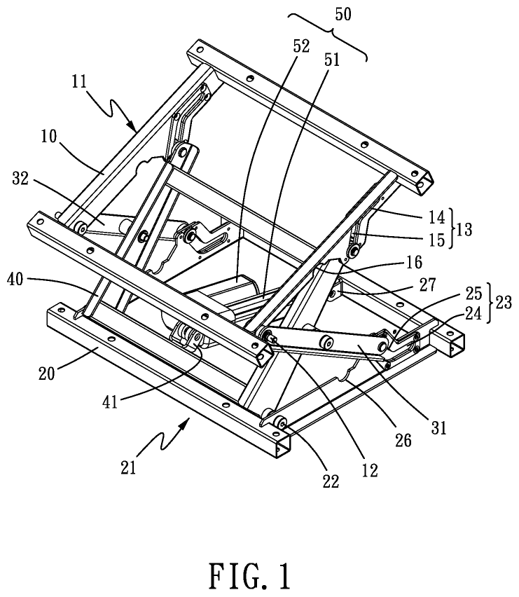

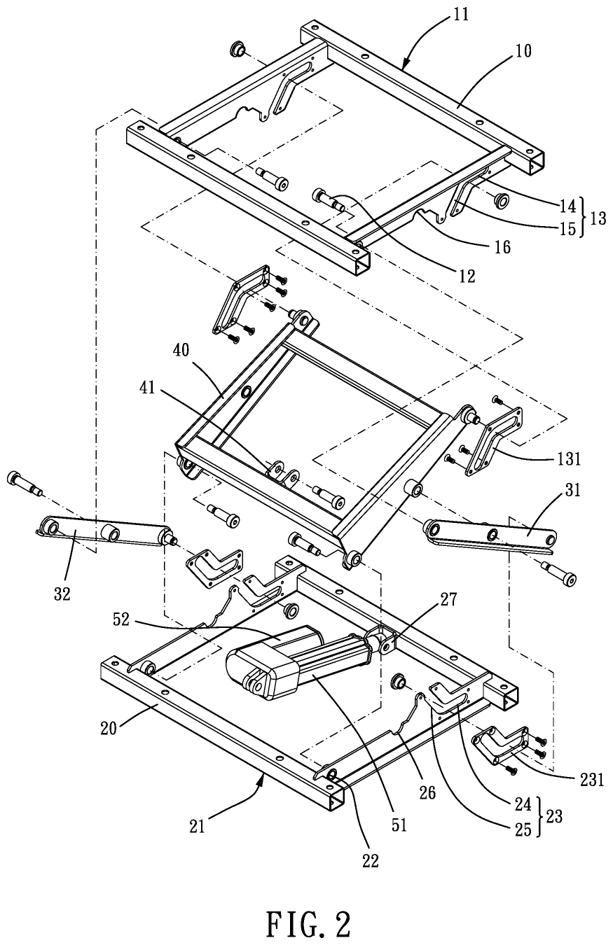

The present invention provides a stand assist device that can be used by the user to seat and assist the user to stand up from the seated state. Please refer to FIG. 1 to FIG. 3, which shows the first embodiment of the present invention, the stand assist device of the embodiment comprises a first frame body 10, a second frame body 20, a first supporting member 30, a second supporting member 40 and a power unit 50.

The first frame body 10 defines a first reference surface 11, such as the upper surface of the first frame body 10, which is also the seating surface for users. The first frame body 10 is having a first pivoting part 12 and a first guiding portion 13. The first pivoting part 12 and the first guiding portion 13 are respectively located on the front side and the rear side of the first frame body 10. The first guiding portion 13 includes a pair of first horizontal groove 14 and first inclined groove 15 on the left and right sides of the first frame body 10. Since the left and right sides of the first frame body 10 have the same structure, the following description will be made only on the left side for elaboration. A first horizontal groove 14 is parallel to the first reference surface 11, and a first inclined groove 15 is not parallel to the first reference surface 11. The first horizontal groove 14 is connected to and extends from one end of the first inclined groove 15, and extends away from the first pivoting part 12. The first inclined groove 15 extends obliquely downward from the first horizontal groove 14 toward the first pivoting part 12, so that the angle between the first inclined groove 15 and the first horizontal groove 14 is greater than 90 degrees. In order to form the first guiding portion 13, the first frame body 10 can be formed by combining tubes and bent plates, configuring a first recess 16 having an opening facing downwardly on the left and right sides of the first frame 10, attaching a plate member 131 fixed around the first inclined groove 15 and the first horizontal groove 14 to increase the rigidity of the first guiding portion 13.

The second frame body 20 is vertically symmetrical with the first frame body 10 and has a substantially similar configuration. In detail, the second frame body 20 defines a second reference surface 21, such as the lower surface of the second frame 20, which is also to be placed on the ground or to be deemed as the bottom surface of the stand assist device. The second frame body 20 is having a second pivoting part 22 and a second guiding portion 23. The second pivoting part 22 and the second guiding portion 23 are respectively located on the front side and the rear side of the second frame body 20. The second guiding portion 23 includes a second horizontal groove 24 and a second inclined groove 25. The second horizontal groove 24 is parallel to the second reference surface 21, and the second inclined groove 25 is not parallel to the second reference surface 21. The second horizontal groove 24 is connected to and extends from one end of the second inclined groove 25 to extend away from the second pivoting part 22. The second inclined groove 25 extends obliquely from the second horizontal groove 24 toward the second pivoting part 22, so that the angle between the second inclined groove 25 and the second horizontal groove 24 is greater than 90 degrees. Similar to the first frame body 10, the second frame body 20 can be formed by combining tubes and bent plates, configuring second recesses 26 on the left and right sides of the second frame body 20. The second recess 26 is having the opening facing downwardly. A plate member 231 is fixed around the second inclined groove 25 and the second horizontal groove 24 to increase the rigidity of the second guiding portion 23 by the plate member 231. Different from the first frame body 10, the second frame body 20 further has a connecting seat 27, disposed on the rear side of the second frame body 20.

The first supporting member includes a left supporting rod 31 and a right supporting rod 32 on the left and right sides. The front side of the left supporting rod 31 and the right supporting rod 32 are pivotally connected to the first pivoting part 12. The rear side of the left supporting rod 31 and the right supporting rod 32 are movably disposed on the second guiding portion 23, so that the rear side of the left supporting rod 31 and the right supporting rod 32 can be moved along the second horizontal groove 24 and the second inclined groove 25 relative to the second frame body 20. The moving path of the rear side of the left supporting rod 31 and the right supporting rod 32 is defined as a first path. The first path extends along the second horizontal groove 24 and the second inclined groove 25. In this embodiment, the left supporting rod 31 and the right supporting rod 32 in the first supporting member are two independent rods. However, it is also feasible if one of the left supporting rod 31 and the right supporting rod 32 is omitted in the first supporting member, or combine the first supporting member into a square or H-shaped frame by connecting the other supporting members between the left supporting rod 31 and the right supporting rod 32.

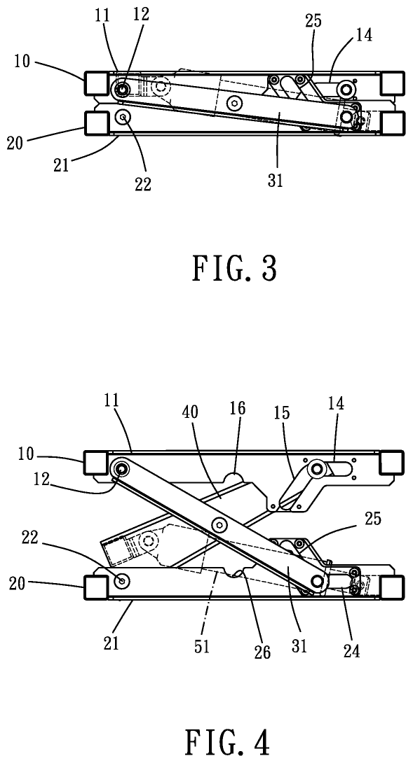

The second supporting member 40 is a frame body formed by combining the tubes and the bent plates. The front side of the second supporting member 40 is pivotally connected to the second pivoting part 22. The front side of the second supporting member 40 has a connecting seat 41 being fixedly disposed thereon and extending backwardly. The rear side of the second supporting member 40 is movably disposed on the first guiding portion 13, so that the rear side of the second supporting member 40 can move along the first horizontal groove 14 and the first inclined groove 15 with respect to the first frame body 10. The moving path of the rear side of the second supporting member 40 is defined as a second path. The second path extends along the first horizontal groove 14 and the first inclined groove 15. The left and right sides of the second supporting member 40 are respectively pivotally connected to the left supporting rod 31 and the right supporting rod 32 of the first supporting member. Wherein, the width of the second supporting member 40 is slightly smaller than the width of the left and right sides of the first frame body 10 and the second frame body 20. The width of the first frame body 10 is also slightly smaller than the width of the second frame body 20. When the stand assist device is folded, as shown in FIG. 3, the second supporting member 40 is received in the first frame body 10 and the second frame body 20, and is not exposed in the side view, and also does not take up space in the thickness of the stand assist device. The space of the first frame body 10 can be partially accommodated in the second frame body 20, so that the horizontal height of the first inclined groove 15 in the first frame body 10 and the second inclined groove 25 in the second frame body 20 has a partial lateral overlapping. Thus, the first inclined groove 15 and the second inclined groove are partially located at the same level, which reduces the thickness of the stand assist device when folding.

The power unit 50 includes an air pressure rod 51 and a compressor 52. The compressor 52 can receive external electric power, compress air into the air pressure rod 51, or control the release of air into the ambient atmosphere to control the air pressure rod 51 to be elongated or shortened. The two ends of the air pressure rod 51 are respectively pivotally connected to the connecting seat 27 and the connecting seat 41, driving the second supporting member 40 to swing relative to the second frame body 20 when the air pressure rod 51 changes its length, thereby driving the first frame body 10 and the second frame body 20 to move closer or away from each other, which drives the first reference surface 11 and the second reference surface 21 to move relatively closer or away from each other. In other possible embodiments of the present invention, the air pressure rod 51 and the compressor 52 can also be altered by the motor and the screw assembly, and similar functions and results can still be obtained.

Please refer to FIG. 3 and FIG. 4, when the power unit 50 is extended to push the second supporting member 40, the second supporting member 40 swings and expands relative to the second reference surface 21 with the second pivot part 22 as a pivot point. The rear side of the second supporting member 40 is moved in the first horizontal groove 14 from the rear end of the first horizontal groove 14 toward the first inclined groove 15. In addition, the extension of second supporting member 40 simultaneously drives the left supporting rod 31 and right supporting rod 32 to swing and expand relative to the first reference surface 11 with the first pivoting part 12 as a pivot point. The rear side of the first supporting member moves from the rear end of the second horizontal groove 24 toward the second inclined groove 25. As the first supporting member and the second supporting member 40 move in the second horizontal groove 24 and the first horizontal groove 14, respectively, the first reference surface 11 and the second reference surface 21 gradually move away but remain parallel, resulting in the first frame body 10 rises vertically.

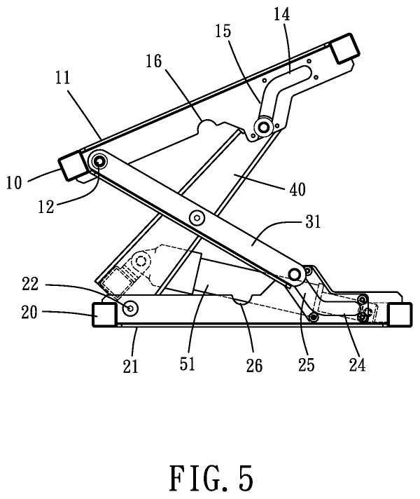

In view of the above, please refer to FIG. 4 and FIG. 5, when the power unit 50 continues to extend, the first supporting member and the second supporting member 40 continue to expand. The rear sides of the left supporting rod 31 and the right supporting rod 32 move into the second inclined groove 25 and move toward the front end of the second inclined groove 25. The rear side of the second supporting member 40 moves into the first inclined groove 15 and moves toward the front end of the first inclined groove 15. As the left supporting rod 31, the right supporting rod 32, and the second supporting member 40 move in the second inclined groove 25 and the first inclined groove 15, respectively, the speed of the rear side of the first reference surface 11 moving away from the rear side of the second reference surface is faster than that of the front sides. The first reference surface 11 is then inclined upwardly with respect to the second reference surface 21, so that the first frame body 10 is inclined upwardly toward the front side.

In general, during the entire process of pushing the second supporting member 40 by the power unit 50, the rear side of the second supporting member moves along the second path relative to the first reference surface 11. The rear side of the first supporting member moves along the first path relative to the second reference surface 21. Wherein the first path is partially non-parallel to the second reference surface 21, and the second path is partially non-parallel to the first reference surface 12, which results in partial non-parallel relationship between the first path and the second path. When the first reference surface 11 and the second reference surface 21 are relatively moved, the first frame body 10 is vertically moved up by a certain distance, and then tilted forward to the front side.

Further, when the power unit 50 provides a pulling force to lower the stand assist device, the first reference surface 11 and the second reference surface 21 move relatively close to each other. The horizontal height of the first inclined groove 15 and the second inclined groove 25 are partially laterally overlapping to each other. This overlap allows the stand assist device to be folded compactly. Furthermore, the middle of two ends of the first frame body 10 has an arc-shaped first recess 16, and the middle of two ends of the second frame body 20 has an arc-shaped second recess 26, wherein the openings of first recess 16 and the second recess 26 are facing each other. When the stand assist device is folded, the accommodation space provided by the first recess 16 and the second recess 26 can accommodate the shaft between the left supporting rod 31, the right supporting rod 32 and the second supporting member 40. In this way, the stand assist device can have a smaller thickness when it is folded and does not occupy much space.

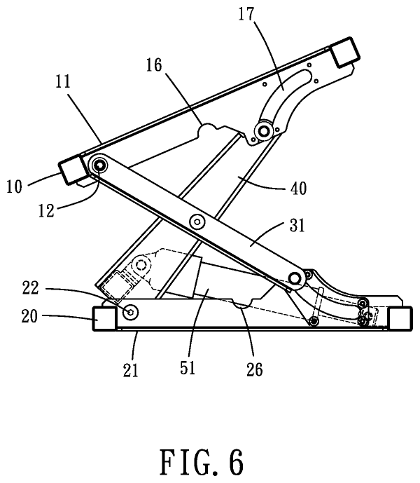

In the above embodiment, the first guiding portion 13 has a first horizontal groove 14 and a first inclined groove 15, and the second guiding portion 23 has a second horizontal groove 24 and a second inclined groove 25, so that in the unfolding process, the first frame 10 is raised first and kept horizontal without tilting. After rising for a certain distance, the front end is tilted and tilted forward. In other possible embodiments of the present invention, please refer to FIG. 6, the first horizontal groove and the first inclined groove can be replaced by an arc groove 17. The rear side of the second supporting member 40 can be movably disposed on the arc groove 17 and can slide along the arc groove 17. The first frame body performs a smaller tilting angle in the former route of the lifting process, and performs a larger tilting angle in the later route of the lifting process. Generally, the functions and results are similar to the previous embodiment.

In the above embodiment, the first guiding portion 13 in the first frame body 10 and the second guiding portion 23 in the second frame body 20 have the same structure, and are arranged to be vertically symmetrical. However, if the first guiding portion 13 and the second guiding portion 23 are one of the guiding portions arranged to have only a single horizontal groove and without the inclined groove or the curved groove, the guiding portion of the first frame body 10 can be driven by another guiding portion having the inclined groove or the curved groove, the function and result are still similar to the previous embodiments.

In the above embodiment, the air pressure rod 51 of the power unit 50 is connected between the connecting seat 27 of the second frame body and the connecting seat 41 of the second supporting member, and can drive the second frame body and the second supporting member to swing relative to each other to make the stand assist device unfolded or folded. Wherein, the first frame body 10, the second frame body 40, the first supporting member and the second supporting member are configured in a linkage relationship, and if the air pressure rod is connected to any portion between the first frame body, the second frame body, the first supporting member and the second supporting member, the two of them can be moved or swing relative to each other, and any portion between the other components in the stand assist device can also be driven together to fold or unfold the stand assist device which has similar effect as previous embodiment.

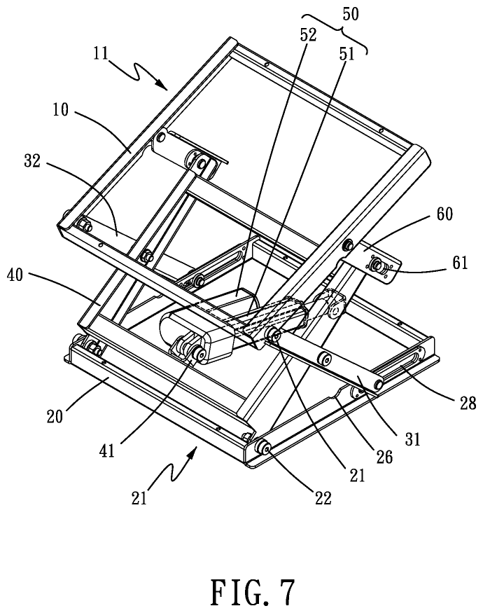

For the second embodiment of the present invention, please refer to FIG. 7. The stand assist device of the second embodiment of the present invention is substantially the same as the first embodiment shown in FIGS. 1 to 5, except that the first guiding portion and the second guiding portion can be changed to other different types. The first guiding portion includes a connecting rod 60. One end of the connecting rod 60 is pivotally connected to the first frame body 10 and pivotable relative to the first reference surface 11. The connecting rod 60 has a first horizontal groove 61. A rear side of the second supporting member 40 is disposed in the first horizontal groove 61 and movable along the first horizontal groove 61. The second guiding portion 23 includes the second horizontal groove 28 without the inclined groove.

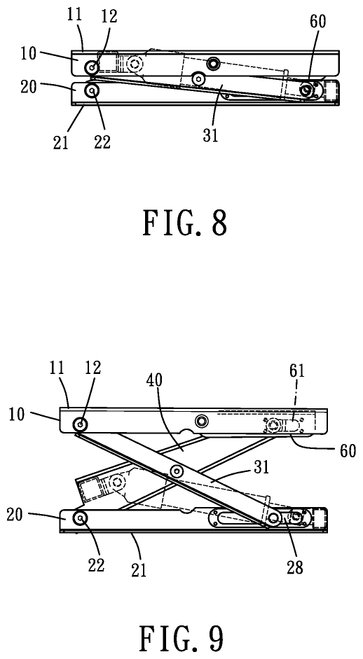

Please refer to FIG. 8 and FIG. 9. When the power unit 50 is extended to push the second supporting member 40, the second supporting member 40 swings and expands relative to the second reference surface 21 with the second pivot part 22 as a pivot point. The rear side of the second supporting member 40 is moved in the first horizontal groove 61 toward the first pivot part 12. In addition, the extension of the second supporting member 40 simultaneously drives the left supporting rod 31 and the right supporting rod 32 swing and expand relative to the first reference surface 11 with the first pivot part 12 as a pivot point. The rear side of the left supporting rod 31 and the right supporting rod 32 are moved in the direction of the second pivotal part 22 in the second horizontal groove 28. As the first supporting member and the second supporting member 40 move in the second horizontal groove 28 and the first horizontal groove 61 respectively, the first reference surface 11 and the second reference surface 21 gradually move away from each other but remain parallel, resulting in the first frame body 10 rises vertically.

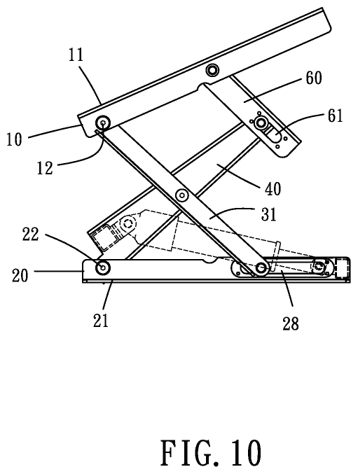

Please refer to FIG. 9 and FIG. 10. When the power unit 50 continues to extend, the first supporting member and the second supporting member 40 continue to swing and expand. Since the rear side of the second supporting member 40 moves to the end of the first horizontal groove 61 close to the pivoting part 12, the second supporting member 40 will drive the connecting rod 60 to pivot relative to the first reference surface 11, causing the first reference surface 11 to be inclined upward relative to the second reference surface 21 and make the first frame body 10 inclined upward toward the front side.

As mentioned above, in the second embodiment of the present invention, the connecting rod 60 can be pivoted to tilt to the first frame body 10. The first frame body 10 has a pure vertical lift during the front section of its lifting route without inclination. Overall, the operational model of the tilting yaw and route is similar to the operation model of the stand assist device described in FIG. 1 to FIG. 5 of the first embodiment.

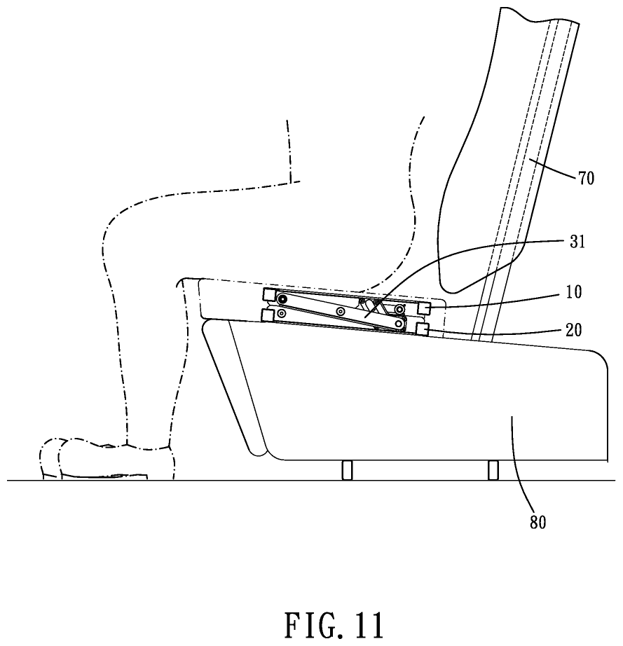

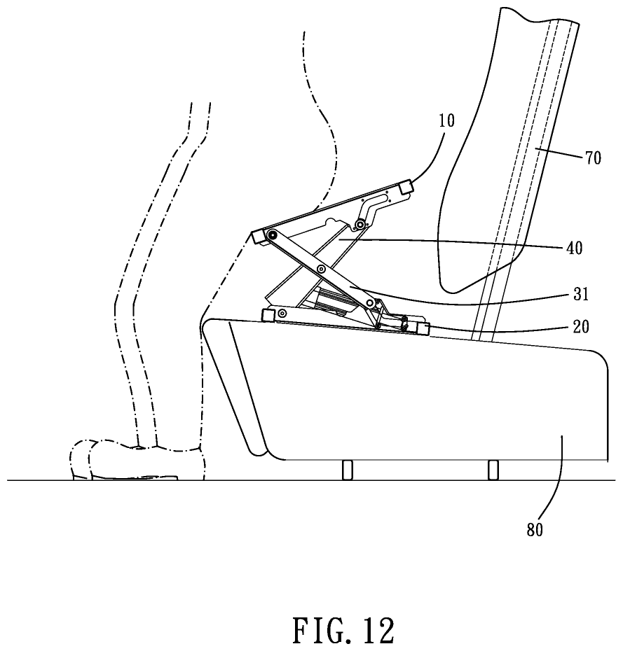

Please refer to the FIG. 11 and FIG. 12, the stand assist device of the present invention can also be installed in a seat. The surface can be covered with a soft cushion. The seat further includes a back frame 70 and a seat frame 80. As shown in FIG. 11 and FIG. 12, the back frame 70 is connected to the seat frame 80, and the second frame 20 is disposed on the seat frame 80, which can provide a pushing force for the user to assist the user to stand up.

In summary, when the user stands up from the sitting position, the user's feet are gradually extended from the knees to the feet during the process of gradually stretching the knees. The stand assist device of the present invention provides vertical upward support, so as to make the user more stable and comfortable during the posture change, and to give a tilting upward support to help the user to stand.

The stand assist device of the present invention provides a labor-saving and comfortable experience during the getting up process. For the elderly or the disabled who move slowly, the present invention provides a safer way for users to get up. The above embodiments are merely illustrative of the technical contents of the present invention, and the patent scope of the patent is subject to the scope of the patent application described later.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. A stand assist device, comprising:
a first frame body, defining a first reference surface, the first frame body having a first pivoting part and a first guiding portion;
a second frame body, defining a second reference surface, the second frame body having a second pivoting part and a second guiding portion;
a first supporting member, a front side of the first supporting member being pivotally connected to the first pivoting part, and a rear side of the first supporting member being movably disposed on the second guiding portion to make the rear side of the first supporting member capable of moving relative to the second frame body along a first path;
a second supporting member, a front side of the second supporting member being pivotally connected to the second pivoting part, and a rear side of the second supporting member being movably disposed on the first guiding portion to make the rear side of the second supporting member capable of moving relative to the second frame body along a second path, and the second supporting member being pivotally connected to the first supporting member;
a power unit, providing a power to relatively move or swing the first frame body, the second frame body, the first supporting member and the second supporting member to cause the first reference surface and the second reference surface relatively moving closer to or away from each other;
wherein at least a portion of the first path and at least a portion of the second path are non-parallel, so that the first reference surface and the second reference surface are relatively swing when moving relative to each other.

2. The stand assist device of claim 1, wherein the first guiding portion is having a first horizontal groove and a first inclined groove, the first horizontal groove is parallel to the first reference surface, the first inclined groove is not parallel to the first reference surface, the first horizontal groove extends away from the first pivoting part from one end of the first inclined groove, and the second path extends along the first horizontal groove and the first inclined groove.

3. The stand assist device of claim 1, wherein the angle between the first horizontal groove and the first inclined groove is greater than 90 degrees.

4. The stand assist device of claim 2, wherein the second guiding portion is having a second horizontal groove and a second inclined groove, the second horizontal groove is parallel to the second reference surface, the second inclined groove is not parallel to the second reference surface, the second horizontal groove extends away from the second pivoting part from one end of the second inclined groove, the first path extends along the second horizontal groove and the second inclined groove.

5. The stand assist device of claim 4, wherein the angle between the second horizontal groove and the second inclined groove is greater than 90 degrees.

6. The stand assist device of claim 4, wherein when the first reference surface and the second reference surface close to each other, the first inclined groove and the second inclined groove partially laterally overlap with each other.

7. The stand assist device of claim 1, wherein the first guiding portion is having an arcuate groove, a rear side of the second supporting member is disposed on the arcuate groove and capable of moving along the arcuate groove.

8. The stand assist device of claim 1, wherein the first guiding portion is having a connecting rod, the connecting rod is pivotable relative to the first reference surface, the connecting rod is having a first horizontal groove, the rear side of the second supporting members is disposed on the first horizontal groove and capable of moving along the first horizontal groove.

9. A seat, comprising the stand assist device according to one of claim 1, further comprising a back frame and a seat frame, the back frame is connecting to the seat frame, the second frame body is disposed on the seat frame.
